(19) United States
(12) Patent Application Publication
(10) Pub. No.: US 2014/0122268 A1
(43) Pub. Date: May 1, 2014

(54) Point-Of-Sale-Customer-Identification Apparatus And Method

(71) Applicant: WAL-MART STORIES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/665,893

(22) Filed: Oct. 31, 2012

(51) Int. Cl. G06Q 20/20; G06K 5/00

(52) U.S. Cl. 705/18; 235/380

(57) ABSTRACT

A method is disclosed identifying a customer during a point-of-sale transaction. Within the method, a computer system may associate or link a first character string to a computing device possessed by a customer. Subsequently, the computer system may initiate a point-of-sale transaction with the customer at a point-of-sale system. In the transaction, the computer system may receive payment data from the customer and first location data from the computing device. From the payment data, the computer system may obtain a second character string. Accordingly, the computer system may identify a match between the first character string and the second character string and between the first location data and second location data corresponding to the point-of-sale system. Thus, the computer system may determine that the computing device is a proper recipient of an electronic receipt documenting the transaction and send the electronic receipt to the computing device.

### BACKGROUND

1. Field of the Invention

This invention relates to point-of-sale systems and more particularly to systems and methods for passing electronic receipt data from a point-of-sale system to a computing device of a customer.

2. Background of the Invention

Many point-of-sale (POS) systems currently in use today do not support important emerging technologies, services, and marketing opportunities. For example, many POS systems are limited in their ability to quickly and securely deliver electronic receipt data to a computing device of a customer. As a result, those POS systems cannot effectively implement many novel methods and services surrounding such data. Accordingly, what is needed is an apparatus and method expanding the ability of a wide variety of POS systems, include legacy POS systems, to pass electronic receipt data from a point-of-sale system to a computing device of a customer.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of one embodiment of a point-of-sale (POS) system for implement methods in accordance with the present invention;

FIG. 2 is a schematic block diagram of one embodiment of multiple POS systems in accordance with the present invention operating in the context of an enterprise-wide system;

FIG. 3 is a schematic block diagram of one embodiment of receipt in accordance with the present invention;

FIG. 4 is a schematic block diagram of one embodiment of a receipt module in accordance with the present invention;

FIG. 5 is a block diagram of one embodiment of a method for passing electronic receipt data from to a computing device of a customer;

FIG. 6 is a block diagram illustrating the flow of selected data within certain embodiments or situations in accordance with the present invention; and

FIG. 7 is a block diagram illustrating the flow of selected data within certain alternative embodiments or situations in accordance with the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide apparatus and methods for passing electronic receipt data from a point-of-sale system to a computing device of a customer. For example, in selected embodiments, a customer may enter a “brick-and-mortar” business location and approach a POS system to begin a transaction. As part of the transaction, the customer may not be expressly identified. Accordingly, a computer system may use certain data to deduce which computing device should properly receive the receipt data.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer of a point-of-sale (POS) system, partly on a POS computer, as a stand-alone software package, on a stand-alone hardware unit, partly on a remote computer spaced some distance from the POS computer, or entirely on a remote computer or server. In the latter scenario, the remote computer may be connected to the POS computer through any type of network, including a local area network (LAN) or a wide area network (WAN), or the connection may be made to an external computer (e.g., through the Internet using an Internet Service Provider).

Embodiments can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

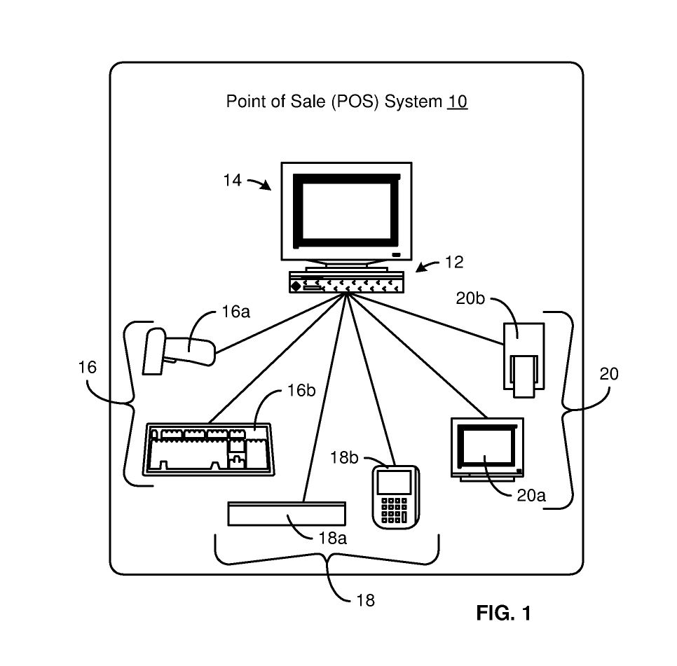

Referring to FIG. 1, in selected embodiments, the hardware, software, or hardware and software of a POS system 10 may be configured to implement one or more methods in accordance with the present invention. For example, a POS system 10 may be manufactured, programmed, modified, or upgraded to support passing of receipt data to a computing device of a customer.

A POS system 10 in accordance with the present invention may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 in accordance with the present invention may include an accounting interface to pass certain information to one or more in-house or independent accounting applications.

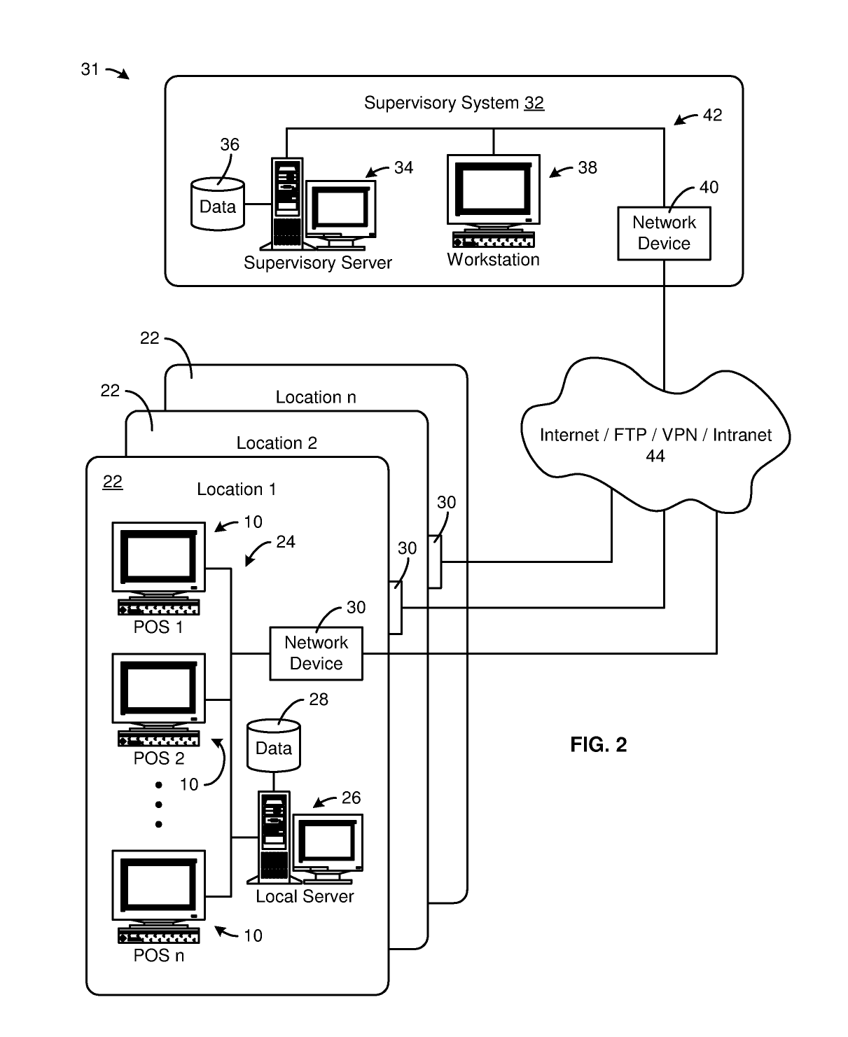

Referring to FIG. 2, in selected embodiments, a POS system 10 may operate substantially independently, as a stand-alone unit. Alternately, a POS system 10 in accordance with the present invention may be one of several POS systems 10 forming the front line of a larger system. For example, multiple POS systems 10 may operate at a particular location 22 (e.g., within a retail, brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 in accordance with the present invention may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

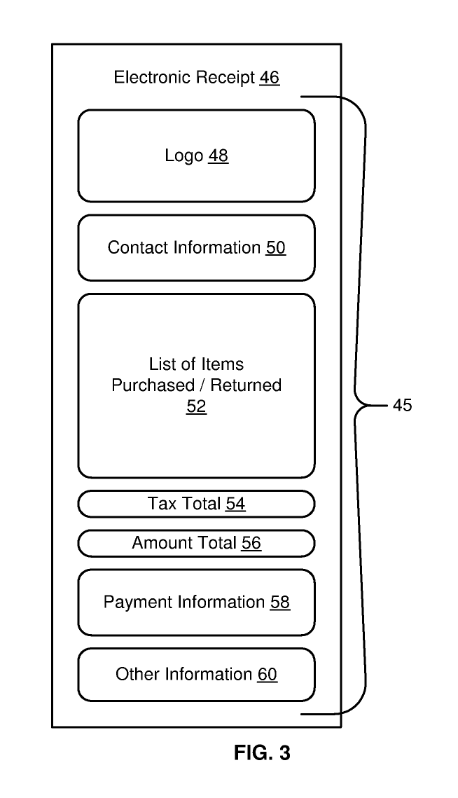

Referring to FIG. 3, a POS system 10 may collect and/or generate receipt data 45. Receipt data 45 may document a transaction (e.g., sale or return) carried out by a POS system 10. Receipt data 45 may be presented or displayed to a customer in the form of an electronic (e.g., paperless) receipt 46. In selected embodiments, receipt data 45 may be delivered to a customer's computing device (e.g., a mobile telephone, personal digital assistant (PDA), media player, tablet computer or reader, laptop computer, desktop computer, or the like, hereinafter a “computing device”) by an entity's computer system (e.g., a system comprising one or more POS systems 10, local servers 26, supervisory servers 34, some other onsite resources, some other offsite resources, or the like or combinations or sub-combinations thereof, hereinafter a “computer system”).

In selected embodiments, receipt data 45 and an electronic receipt 46 may include a logo 48, contact information 50, a list 52 of items purchased or returned, a total 54 indicating the sales tax assessed or returned, a total 56 indicating the amount paid or returned, payment information 58, other information 60, or the like or combinations or sub-combinations thereof.

A logo 48 may reinforce the brand and image of the associated entity within the mind of a consumer. By including contact information 50 on an electronic receipt 46, an entity may ensure that a customer has ready access to one or more physical addresses, Internet address, telephone numbers, facsimile numbers, hours of operation, or the like or combinations or sub-combinations thereof. One or more of a list 52 of items purchased or returned, a total 54 indicating the sales tax assessed or returned, a total 56 indicating 56 the amount paid or returned, and payment information 58 (e.g., date of transaction, an indication of method of payment, an indication of which credit or debit card was used, etc.) may be included to document important details of a transaction.

Other information 60 may be included within an electronic receipt 46 as desired or necessary. For example, to promote brand loyalty, an entity may include an indication of an amount saved in the transaction, a yearly total of the amount saved, reward points earned, or the like. Alternatively, or in addition thereto, other information 60 may include promotional information, a solicitation to participate in a survey, an employment opportunity, contest information, or the like.

An electronic receipt 46 may be presented by a computing device of a customer in any suitable layout or format. For example, the receipt data 45 forming an electronic receipt 46 may simply be presented as a textual list. Alternatively, an electronic receipt 46 may follow the form of a paper receipt. That is, the electronic receipt 46 may comprise a virtual representation or layout substantially matching what a comparable paper receipt would look like.

The manner in which an electronic receipt 46 is presented or displayed on a computing device of a customer may be completely dictated by the computer system delivering the receipt data 45 thereto. Alternatively, the computing device of the customer may have an application (e.g., a receipt manager, accounting program, budgeting program, or the like) installed thereon. Such an application may partially or completely control the layout or format of an electronic receipt 46 displayed therewith or therethrough. For example, a computer system may supply receipt data 45, while the application installed on the computing device of the customer supplies the layout or formatting.

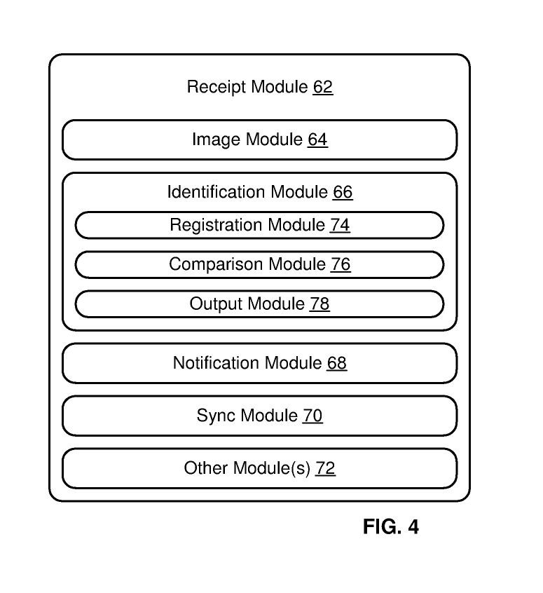

Referring to FIG. 4, a computer system in accordance with the present invention may deliver receipt data 45 to a computing device of a customer in any suitable manner. In selected embodiments, a receipt module 62 may enable or support such delivery. A receipt module 62 may include any suitable arrangement of sub-components or modules. In certain embodiments, a receipt module 62 may include an image module 64, identification module 66, notification module 68, synchronization module 70, one or more other modules 72 as desired or necessary, or the like or some combination or sub-combination thereof.

An image module 64 may assemble, generate, or obtain an advertisement comprising a call to action. A call to action may invite or motivate a customer to take a particular step or action. For example, a call to action may invite or motive a consumer to download receipt data 45. To increase the likelihood that a consumer will respond favorably to the call to action, an advertisement may include an enabler facilitating the desired step or action. For example, in selected embodiments, an advertisement may include a machine-readable code. By scanning the code (e.g., scanning the code using a camera on a mobile telephone, tablet computer, or the like), a consumer may import receipt data 45 encoded within the code. Alternatively, scanning the code may initiate the download of receipt data 45.

For example, a machine-readable code may be encoded with a URL. In addition to designating a particular resource, a URL may also include a transaction identification (ID). Accordingly, after an appropriate application is launched and a machine-readable code is scanned, a URL may be passed from a customer (e.g., from a mobile telephone of a customer) to an Internet Service Provider (e.g., a telecommunications provider). As a result, an appropriate resource within a computer system may be accessed and receipt data may be returned to (e.g., downloaded by) a computing device.

In selected embodiments, a machine-readable code may comprise a barcode. For example, in certain embodiments, a machine-readable code may comprise a two-dimensional barcode. Two-dimensional barcodes may support or provide more data per unit area than can be obtained using a traditional one-dimensional barcode. Moreover, two-dimensional barcodes are typically configured to be scanned using a camera, an item that is commonly found on personal electronic devices. A two-dimensional barcode for use in accordance with the present invention may follow any suitable protocol, format, or system. In selected embodiments, a two-dimensional code may be embodied as a Quick Response (QR) Code.

An identification module 66 may be tasked with requesting, collecting, and/or communicating identification information linking a customer associated with a transaction with one or more records stored within a computer system. For example, as part of a transaction carried out at a POS system 10, an identification module 66 may request, collect, deduce, and/or communicate identification information linking a transaction to one or more computing devices corresponding to the customer participating in the transaction. Thus, information corresponding to the transaction may be passed to the customer via an appropriate computing device.

In selected embodiments, an identification module 66 may be tasked with requesting, collecting, and/or communicating identification information linking a customer associated with a transaction to an account contained within a computer system. Such an account may then be accessed (e.g., logged onto) using a computing device. Accordingly, information corresponding to the transaction may be passed to the customer via an appropriate (e.g., authorized) computing device. In certain embodiments, should a customer desire to un-associate a computing device from a computer system or from his or her records stored within a computer system, the customer may log the computing device out of the account.

An identification module 66 may request, collect, and/or communicate one or more types of identification information. For example, in selected embodiments, an identification module 66 may collect a unique identification or membership number from a customer. This may be done when a membership card, club card, loyalty card, identification card, credit card, debit card, fingerprint or other biometric characteristic, or the like is scanned, input, or otherwise collected at a POS system 10. In other situations, a cashier or customer may type in a unique identification number, payment number, membership number, or the like at a POS system 10. For example, while a cashier is processing a transaction, a customer may be prompted via a card reader 18b, customer-facing display 20, or the like to enter (e.g., type in using the card reader 18b) a mobile telephone number corresponding to the customer.

Alternatively, or in addition thereto, an identification module 66 may be programmed to identify a customer (e.g., identify a computing device corresponding to a customer) without requiring any additional entry of identification data by a customer during a transaction. For example, an identification module 66 may deduce an identification from certain data forming part of the transaction, data entered or communicated previously by a customer, or the like or a combination thereof.

To accomplish the functions corresponding thereto, an identification module 66 may include any suitable arrangement of sub-components or modules. In certain embodiments, an identification module 66 may include a registration module 74, comparison module 76, output module 78, one or more other modules as desired or necessary, or the like or a combination or sub-combination thereof.

A registration module 74 may assist in registering one or more customers. Registration may include linking or associating certain data (e.g., one or more character strings) corresponding to a customer to a computing device in the possession of the customer. For example, in selection embodiments, a registration module 74 may link or associate one or more account numbers, portions of account numbers, hashes of account numbers, or the like or combinations or sub-combinations thereof to a particular computing device. In such embodiments, a character string used or recorded in a registration process may be derived directly from an account number or, alternatively, from an algorithm, hash, or the like applied to an account number. Accordingly, when a customer uses a “registered” account number (e.g., to make a payment) in a transaction, a computer system may recognize the transaction as corresponding to a particular customer and a particular computing device.

A registration module 74 may collect data, one or more character strings, or the like in any suitable manner. In selected embodiments, such information may be collected in an installation or activation process. For example, installation or activation of an application (e.g., an electronic-receipts application) or some portion or feature thereof on a computing device of a customer may result in the customer being prompted to enter certain data, one or more character strings (e.g., data correspond to one or more accounts), or the like.

Alternatively, a registration module 74 may act in a more automated manner. For example, in an initial POS transaction, a customer may enter in a mobile telephone corresponding to his or her computing device, scan an advertisement using his or her computing device, or the like and pay using some account number. Accordingly, a registration module 74 may determine that a particular computing device and a particular account number have been used in conjunction with the same transaction and, as a result, generate an electronic record associating the two. Thus, in future transactions where the same account number is used, the customer need not enter in the telephone number, scan the advertisement, or the like to identify the customer or the computing device of the customer. This process may be repeated until all the account numbers used by a customer have been registered.

A comparison module 76 may be programmed to compare various data in an effort to identify matches or potential matches. In certain embodiments, a comparison module 76 may receive a character string collected as part of a POS transaction and search certain computer records to identify any computing device or devices corresponding thereto. For example, a comparison module 76 may receive, extract, or generate an account number, portion of an account numbers, hash of an account number, or the like as part of a POS transaction. A comparison module 76 may then search certain computer records to identify any computing device or devices that have been linked to or associated with the account number, portion of the account number, hash of the account number, or the like.

In selected embodiments, a comparison between two character strings may produce multiple possible matches, rather than a single conclusive match. For example, in selected embodiments, a character string may comprise just a portion or subset of a debit or credit card account number (e.g., the last four digits of a debit or credit card account number). Such embodiments may be beneficial in terms of customer privacy, fraud protection, lower transactional costs, Payment Card Industry (PCI) compliance, or the like. However, such character strings may too short (e.g., offer too few permutations) to be unique among a particular set of customers. Accordingly, in certain embodiments, to more concretely establish a proper identity, a comparison module 76 may search, compare, or match more than just character strings.

For example, in selected embodiments, a comparison module 76 may compare location data. That is, a POS system may be associated with one physical location (e.g., latitude and longitude data corresponding to the physical location occupied by a brick-and-mortar store, latitude and longitude data corresponding to the physical location occupied by a POS system, or the like). This physical location may be known by, stored in, or communicated to a computer system. A customer may be associated with another physical location (e.g., latitude and longitude data determined and reported by a computing device carried by a customer). As a result, a comparison module 76 may obtain, access, analyze, or search one or more character strings as well as certain location data to between establish an identification.

An output module 78 may communicate one or more outputs of an identification module 66 to one or more associated modules operating in cooperation therewith. For example, an output module 78 may output identification information to a notification module 68, sync module 70, or the like. In selected embodiments, once the identification information is so received, it may be used to pass receipt data 45 to a computing device of a corresponding customer.

A notification module 68 may assemble, generate, obtain, direct, and/or issue one or more push notifications. In selected embodiments, push notifications may be directed to a computing device of a customer. For example, when an appropriate application in not running on a computing device, push notifications may inform the customer that certain data or options are available (e.g., that a new electronic receipt 46 is available for download).

A synchronization module 70 may support or enable one way or two way data communication between a computer system and a computing device. For example, a synchronization module 70 may support or enable the passing of receipt data 45 from a computer system to a computing device. A synchronization module 70 may also enable certain data received from a computing device to be incorporated within or used by a computer system. For example, one or more user preferences (e.g., notification preferences) may be communicated to a computer system from an application resident on a computing device.

The various functions or modules of a receipt module 62 may be enacted or implemented by any suitable system or component thereof. For example, in selected embodiments, one or more functions or modules of a receipt module 62 may be distributed across one or more hardware devices, including a primary computer 12 of a POS system 10, a local server 26, a supervisory server 34, some other onsite resource, a computing device, some other offsite resource, or the like or combinations or sub-combinations thereof. Thus, systems and methods in accordance with the present invention may be adapted to a wide variety of situations, including more rigid legacy systems.

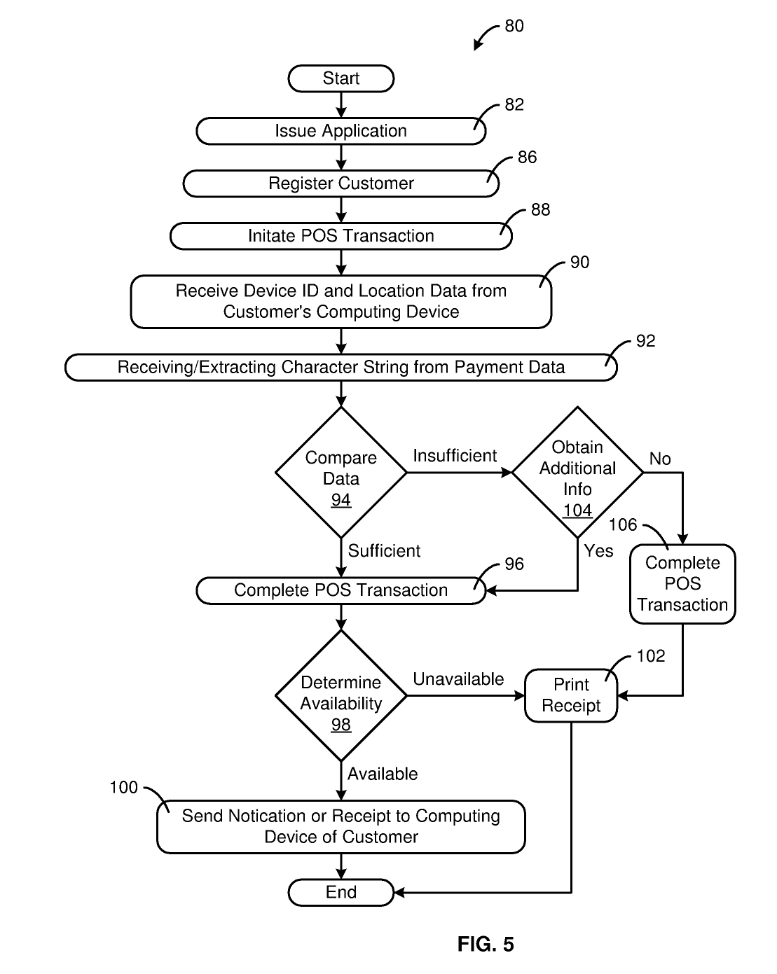

Referring to FIG. 5, one method 80 in accordance with the present invention may begin when an application programmed to receive, format, display, categorize, and/or analyze receipt data 45 is issued 82 and installed on a computing device of a customer. The customer may then be registered 86 with respect to or on a computer system. This may result in the computing device being linked to or associated with a particular character string as discussed hereinabove. So prepared, a customer may then enter a “brick-and-mortar” business location (e.g., a brick-and-mortar retail store) with his or her computing device and approach a POS system 10. At the POS system 10, a transaction (e.g., a purchase, return, or the like) may be initiated 88.

In association with such a transaction, a computer system may receive 90 certain data from a computing device of a customer. For example, a computer system may receive 90 information uniquely identifying a computing device possessed (e.g., carried) by a customer. Alternatively, or in addition thereto, a computer system may receive 90 location data identifying a physical location occupied by a computing device. This may happen in any suitable manner.

In selected embodiments, an application running on a computing device may pass a unique identifier and location data to a computer system. For example, during or shortly before a transaction, a customer may access an application and inform the application (e.g., select a button indicating) that he or she is waiting for an electronic receipt. When the application is so informed, it may collect certain information and send it to a computer system. For example, the application may send a unique identifier and location data (e.g., latitude and longitude data derived from a GPS system resident on the computing device). In view of one or more links or associations previously made and recorded, a computer system may recognize the unique identifier and, therefore, know (or be able to retrieve) one or more first character strings corresponding to the computing device.

As part of a transaction, a customer may submit some form of payment. For example, a customer may provide a debit or credit card. Accordingly, a POS system 10 may scan or read a debit or credit card and obtain payment data (e.g., an account number) therefrom. Using the payment data, a computer system may receive 92, extract 92, or derive 92 a character string.

In selected embodiments, a character string may comprise an entire account number, a portion or subset of an account number, a composite made from the joining of two or more portions of an account number, a hash of an account number, or the like. Accordingly, in such embodiments, a character string may be derived directly from payment data or from an algorithm, hash, or the like applied to an account number. The algorithm, hash, or the like used on payment data may be same one used during registration 86. Accordingly, character strings recorded during registration 86 may be directly comparable to character strings received 92, extracted 92, derived 92 from payment data received during a subsequent transaction.

Once the various forms of data have been received 90, 92, a computer system may compare 94 it against other data to determine how best to handle a receipt corresponding to the transaction. In selected embodiments, the comparison 94 may comprise a simple search to identify which computing device is linked to a particular character string derived from payment data submitted during the transaction. If only one such computing device is identified and certain guarantees exist that the match is unique, then there may be sufficient evidence for the computer system to complete 96 the POS transaction knowing that the proper computing device has been identified. However, in certain applications, situations, or embodiments, a matching character string, by itself, may be insufficient. Accordingly, other data may be used or compared 94.

For example, as set forth hereinabove, location data may be used to ensure an accurate identification of a proper computing device is achieved. A computer system may know or be informed of location data corresponding to a POS system 10 at which the transaction is taking place. The precision of this location data may vary between embodiments. For example, in selected embodiments, certain POS systems 10 within a particular location 22 may all correspond to the same location data. Alternatively, each POS system 10 at a location 22 may correspond to location data specific thereto.

The location data corresponding to a POS system 10 may be compared to the location data being reported by one or more computing devices. Accordingly, when a character string is derived from a transaction occurring at a particular POS system 10 and a computing device linked to that character string reports a position near (e.g., within a threshold selected from a range of about 1 to 100 meters) the particular POS system 10, then a computer system may determine that a sufficiently accurate identification of a proper computing device has been achieved.

In selected embodiments, certain probabilities of an erroneous determination of identification may be persistent. That is, in certain embodiments, it may be difficult or impossible to remove all chance of an erroneous conclusion that a particular transaction corresponds to a particular computing device. However, in such embodiments, steps may be taken to ensure that sufficient evidence is in place to conclude that a proper identification has been determined or deduced.

For example, to strengthen a particular identification, character strings, location data, and the like of additional transactions, POS systems 10, or computing devices may be taken into account. In certain embodiments, the number and typically locations of computing devices linked to identical character strings may be taken into account. Alternatively, or in addition thereto, a computer system may consider location data reported by other computing devices in the vicinity of (e.g., same store as) a particular POS system 10 within a given period of time, the character strings linked to other computing devices in the vicinity of a particular POS system 10 within a given period of time, character strings concurrently derived from other POS systems 10 in the vicinity of the particular POS system 10, or the like or a combination or sub-combination thereof.

When the data is sufficient, a proper computing device may be identified. Accordingly, the corresponding POS transaction may be completed 96. Subsequently, a determination 98 may be made as to whether the proper computing device is available. If an appropriate computing device is available, a push notification, receipt data 45, or the like may be sent 100 to the computing device. Thus, a customer may receive and store an electronic receipt on his or her computing device. If an appropriate computing device is not available, some other action may be taken.

For example, at some point (e.g., after an application has reported certain location data), a customer may turn off his or her computing device. Alternatively, a necessary application may be closed and push notifications may be unavailable (e.g., a push notification function may be unsupported or disabled). Accordingly, an appropriate computing device may be unavailable. In such situations, a POS system 10 may simply print 102 a paper receipt.

When a comparison 94 reveals that the data is insufficient to identify an appropriate computing device, a computer system may obtain 104 additional information to resolve any relevant ambiguity. For example, a computer system may request a customer to type in a number (e.g., type a telephone number into a card reader 18b), enter a code, number, or the like provided on a customer-facing display 20a into an application running on his or her computing device, or the like. If additional, clarifying information is obtained 104, then the relevant POS transaction may be completed 96 and the method 80 may continue as described hereinabove. Alternatively, if no additional information is obtained 104 (e.g., no additional information is requested or additional information is requested by not timely received), then the POS transaction may be completed 106 and a POS system 10 may simply print 102 a paper receipt.

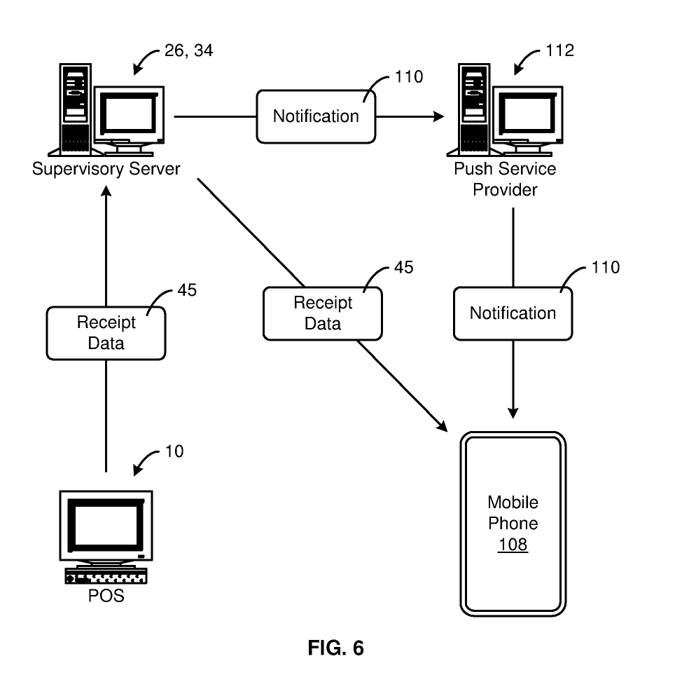

Referring to FIG. 6, once a transaction has been completed 96 and a computing device determined 98 to be available, receipt data 45 may be passed to an appropriate computing device (e.g., mobile phone 108). In selected situations or embodiments, this may be done using a push notification 110. A push notification 110 may be short message comprising a device token and a payload. A device token may contain information that enables a push service provider 112 (e.g., Apple Push Notification Service, Android Cloud to Device Messaging (C2DM), or the like) to locate the appropriate computing device on which the application is installed. A device token may also permit a push service provide 112 to authenticate the routing of a push notification 110.

A payload of a push notification 110 may comprise various data. In general, the nature and extent of the payload may be controlled by the specifications and features imposed or provided by a push service provider 112. Some providers 112 may support significantly more data and/or functionality in association with push notifications 110. In selected embodiments, a payload may comprise a property list specifying how a customer associated with the computing device is to be alerted. For example, a payload may specify an alert message to display to the customer (e.g., “You have a new electronic receipt”), a number with which to badge the application icon, a notification sound or vibration to play or execute, or the like.

A computer system in accordance with the present invention may send a push notification 110 soon after the completion 96 of the transaction. Once a push notification 110 is received by a computing device, a customer may choose how he or she would like to respond. For example, in viewing an alert generated on a computing device by a push notification 110, a customer may be presented with the options of closing the alert and launching the corresponding application. Should the customer elect to close the alert, the alert may be closed and the computing device may wait until the next launch to synchronize or download receipt data 45.

If the customer elects to launch the application, then the application may be launched on the computing device. In selected embodiments, the launching of the application may automatically trigger synchronization or download of any new receipt data 45. Alternatively, the launching of a particular portion the application (e.g., a receipts portion) may automatically trigger synchronization or download of any new receipt data 45. Such processes or certain portions thereof may be repeated with one or more subsequent transactions. Accordingly, an application resident on a computing device may collect a data set useful for budgeting, electronic search of transaction data, couponing, shopping lists, electronic backup of transaction data, sharing of transaction data with family, friends, and/or co-workers, tracking of expenses for business or tax purposes, or the like or combinations or sub-combinations thereof.

In selected alternative embodiments, a push notification 110 may carry significantly more data (e.g., payload) than simply an alert message, alert sound, and the like. For example, a push notification 110 may carry certain receipt data 45 to a computing device. In certain embodiments, such a push notification 110 may prompt a customer to launch an application in order to receive, store, and display all of the receipt data 45 carried in the push notification 110. Alternatively, the receipt data 45 carried by a push notification 110 may be incorporated with the records or database of an application without regard to whether the application is fully launched.

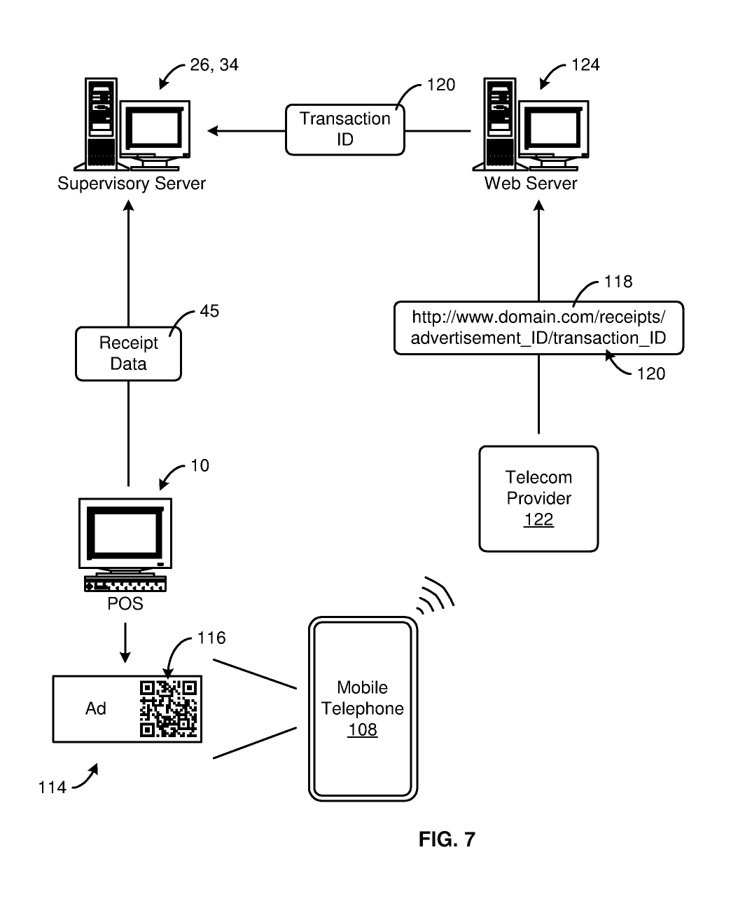

Referring to FIG. 7, in certain embodiments, a computer system may enable a customer to receive an electronic receipt even when a paper receipt issued. For example, a POS system 10 may present an advertisement 114 to a customer via a printed paper receipt. Alternatively, or in addition thereto, an advertisement 114 (e.g., the same advertisement 114 or a different advertisement 114) may be presented to a customer via a customer-facing display 20a.

A machine-readable code 116 contained within an advertisement 114 may be encoded 118 with receipt data 45. Accordingly, should a customer respond to a call to action and wish to import receipt data 45, he or she may launch an appropriate application and scan the machine-readable code 116 of an advertisement 114 presented to him or her. For example, a customer may scan an advertisement 114 using the camera of a mobile telephone 108. This may occur at the POS system 10 (e.g., from customer-facing display 20a) or sometime later using an advertisement 114 printed on a paper receipt or on a piece of paper sized only to accommodate the advertisement 114. By decoding the machine-readable code 116, the application may obtain and import the corresponding receipt data 45.

Alternatively, in selected methods, a machine-readable code 116 may be encoded with a URL 118. In addition to designating a particular resource, a URL 118 may also include certain identifications. For example, a URL 118 may include a transaction ID 120. Accordingly, after an appropriate application is launched and a machine-readable code 116 is scanned, a URL 118 may be passed from a computing device (e.g., from a mobile telephone 108 of a customer) to an Internet Service Provider (e.g., a telecommunications provider 122). As a result, an appropriate resource within a computer system may be accessed and receipt data 45 may be returned to (e.g., downloaded by) the computing device.

For example, in selected embodiments, a request may reach a web server 124 corresponding to the URL 118. The request may include the transaction ID 120. Thus, a web server 124 may pass the transaction ID 120 to a local server 26, a supervisory server 34, other resource, or the like. In response, receipt data 45 may be passed back (e.g., through the web server 124, telecommunications provider 122, or the like) to the computing device.

The flowchart and block diagrams in FIGS. 5-7 illustrate the architecture, functionality, and operation of possible implementations of systems, methods, and computer program products according to certain embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

It should also be noted that, in some alternative implementations, the functions noted in the blocks may occur out of the order noted in the Figures. In certain embodiments, two blocks shown in succession may, in fact, be executed substantially concurrently, or the blocks may sometimes be executed in the reverse order, depending upon the functionality involved. Alternatively, certain steps or functions may be omitted if not needed.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for determining where to send an electronic receipt documenting a point-of-sale transaction, the method comprising:
storing, by a computer system comprising a point-of-sale system, a record linking a first character string to a computing device possessed by a customer, the first character string comprising at least one of an account number, a portion of an account number, and a hash of an account number;
initiating, by the point-of-sale system after the storing, a transaction involving the customer;
determining, by the computer system, whether to send receipt data documenting the transaction to a receipt printer associated with the point-of-sale system or to the computing device possessed by the customer, the determining comprising
receiving, by the computer system in association with the transaction, payment data from the customer and first location data from the computing device,
obtaining, by the computer system, a second character string from the payment data, and
identifying, by the computer system, a match between the first character string and the second character string and between the first location data and second location data corresponding to the point-of-sale system; and
sending, by the computer system based on the determining, an electronic receipt documenting the transaction to the computing device.

2. The method of claim 1, further comprising receiving the customer within a brick-and-mortar location.

3. The method of claim 2, wherein the initiating comprising initiating the transaction at the point-of-sale system contained within the brick-and-mortar location.

4. The method of claim 3, wherein the computing device comprises a mobile telephone.

5. The method of claim 3, wherein the receiving comprises scanning, by the point-of-sale system, a card provided by the customer.

6. The method of claim 5, wherein the obtaining comprises obtaining the second character string from two or more characters of an account number associated with the card.

7. The method of claim 6, wherein the receiving comprises receiving the first location data in the form of first latitude and longitude data identifying a first physical location of the computing device.

8. The method of claim 7, wherein the identifying the match between the first location data and the second location data comprises determining that the first physical location is within a selected threshold of proximity to a second physical location corresponding to the point-of-sale system.

9. The method of claim 8, wherein the first character string comprises two or more numbers selected from an account number corresponding to a debit or credit card possessed by the customer.

10. The method of claim 9, wherein the second character string comprises the two or more numbers.

11. The method of claim 1, wherein the receiving comprises receiving the first location data in the form of first latitude and longitude data identifying a first physical location of the computing device.

12. The method of claim 11, wherein the identifying the match between the first location data and the second location data comprises determining that the first physical location is within a selected threshold of proximity to a second physical location corresponding to the point-of-sale system.

13. The method of claim 11, wherein the identifying the match between the first location data and the second location data comprises determining that the first physical location is within a selected threshold of proximity to a second physical location occupied by the point-of-sale system.

14. A method for determining where to send an electronic receipt documenting a point-of-sale transaction, the method comprising:
storing, by a computer system comprising a point-of-sale system, a record linking a character string to a computing device possessed by a customer, the character string comprising at least one of a first account number, a portion of a first account number, and a hash of a first account number;
initiating, by the point-of-sale system after the storing, a transaction involving the customer;
determining, by the computer system, whether to send receipt data documenting the transaction to a receipt printer associated with the point-of-sale system or to the computing device possessed by the customer, the determining comprising
receiving, by the computer system in association with the transaction, the first account number from the customer and first location data from the computing device, the first location data identifying a first physical location occupied by the computing device,
obtaining, by the computer system, a second character string from the first account number,
confirming, by the computer system, that the first character string matches the second character string, and
confirming, by the computer system, that the first physical location is within a selected distance of a second physical location corresponding to the point-of-sale system; and
sending, by the computer system based on the determining, an electronic receipt documenting the transaction to the computing device.

15. The method of claim 14, further comprising receiving the customer within a brick-and-mortar location.

16. The method of claim 15, wherein the initiating comprising initiating the transaction at the point-of-sale system contained within the brick-and-mortar location.

17. The method of claim 16, wherein computing device comprises a mobile telephone.

18. The method of claim 17, wherein the receiving comprises reading, by the point-of-sale system, the first account number from a debit or credit card provided by the customer.

19. The method of claim 18, wherein the confirming comprise confirming that the first physical location is within a selected distance of a second physical location occupied by the point-of-sale system.

20. (canceled)

21. A method for determining where to send an electronic receipt documenting a point-of-sale transaction, the method comprising:
storing, by a computer system comprising a point-of-sale system, a record linking a first character string to a computing device possessed by a customer, the first character string comprising at least one of an account number, a portion of an account number, and a hash of an account number;
initiating, by the point-of-sale system after the storing, a transaction involving the customer;
determining, by the computer system, whether to send receipt data documenting the transaction to a receipt printer associated with the point-of-sale system or to the computing device possessed by the customer, the determining comprising
receiving, by the computer system in association with the transaction, payment data from the customer and first location data from the computing device,
obtaining, by the computer system, a second character string from the payment data,
comparing, by the computer system, the first character string and the second character string, and
comparing, by the computer system, the first location data and second location data corresponding to the point-of-sale system;
sending, by the computer system, an electronic receipt documenting the transaction to the computing device if the first character string matches the second character string and the first location data matches the second location data; and
sending, by the computer system, receipt data documenting the transaction to the receipt printer of the point-of-sale system if the first character string does not match the second character string or if the first location data does not match the second location data.
